(19) United States
(12) Patent Application Publication
(10) Pub. No.: US 2026/0247159 A1
(43) Pub. Date: Aug. 20, 2026

(54) MULTI-OPERATOR RADIO ACCESS NETWORK (RAN) FRAMEWORK FOR CITIZENS BROADBAND RADIO SERVICE (CBRS) NETWORKS

(71) Applicant: Charter Communications Operating, LLC, St. Louis, MO (US)

(72) Inventors: Saran Khalid, Denver, CO (US); MohammedYusuf M. Shaikh, Aurora, CO (US); Perwaiz Akhtar, Aurora, CO (US)

(21) Appl. No.: 19/057,719

(22) Filed: Feb. 19, 2025

(51) Int. Cl. H04W 16/14; H04W 60/00; H04W 72/0453; H04W 72/30

(52) U.S. Cl. CPC H04W 16/14; H04W 60/00; H04W 72/0453; H04W 72/30

(57) ABSTRACT

A computing system is provided that is configured to implement a multi-operator radio access network (RAN) framework in a wireless network operating in the Citizens Broadband Radio Service (CBRS) frequency band that allows a plurality of different network operators to share the same CBRS network infrastructure. In particular, the computing system is configured to generate a consolidated registration object associated with a plurality of different network operators. The consolidated registration object includes a requested frequency range (e.g., a plurality of CBRS channels) in the CBRS band. The computing system is further configured to cause a Citizens Broadband Radio Service device (CBSD), such as an eNodeB and/or a gNodeB, to operate on the requested frequency range identified by the consolidated registration object.

### BACKGROUND

Some wireless communication networks and systems, or particular regions of wireless spectrum, may include shared communications bands in which certain frequency bands are shared between users and/or entities. For instance, the Citizens Broadband Radio Service (CBRS) refers to a shared region of wireless spectrum that allows different entities (e.g., governmental entities, commercial entities, private entities, etc.) to dynamically utilize spectrum (e.g., certain frequency bands) rather than relying on static spectrum allocation frameworks. The CBRS spectrum is a 150 MHz wide band in the 3.5 GHz spectrum (3550–3700 MHz) and is divided into fifteen (15) 10 MHz wide channels.

The Federal Communications Commission (FCC), which manages aspects of the CBRS, has introduced three tiers of access for the CBRS: incumbent entities, Priority Access License (PAL) holding entities, and General Authorized Access (GAA) entities. CBRS access is tiered so that “non-priority” entities (e.g., businesses, network service providers, etc.) do not interfere with “priority” entities. For example, in response to a spectrum access request (e.g., CBRS access request) from an incumbent entity, CBRS access may be revoked from non-incumbent entities (e.g., PAL entities, GAA entities, etc.) that are likely to cause interference with the incumbent entity.

### SUMMARY

The examples disclosed herein implement a method and framework for implementing multi-operator radio access network (RAN) in a wireless network operating in the Citizens Broadband Radio Service (CBRS) frequency band.

In one implementation, a method is provided. The method includes generating, by a computing system comprising one or more computing devices, a consolidated registration object associated with a plurality of different network operators, the consolidated registration object identifying a requested frequency range in a Citizens Broadband Radio Service (CBRS) network, the requested frequency range comprising a plurality of CBRS channels, at least one CBRS channel being associated with each network operator of the plurality of different network operators. The method further includes causing, by the computing system, a Citizens Broadband Radio Service device (CBSD) to operate on the requested frequency range identified by the consolidated registration object.

In another implementation, a computing system is provided. The computing system includes one or more computing devices. The one or more computing devices are operable to generate a consolidated registration object associated with a plurality of different network operators, the consolidated registration object identifying a requested frequency range in a Citizens Broadband Radio Service (CBRS) network, the requested frequency range comprising a plurality of CBRS channels, at least one CBRS channel being associated with each network operators of the plurality of different network operators. The one or more computing devices are further operable to cause a Citizens Broadband Radio Service device (CBSD) to operate on the requested frequency range identified by the consolidated registration object.

In another implementation, a non-transitory computer-readable storage medium is provided. The non-transitory computer-readable storage medium includes executable instructions configured to cause a processor device of a computing system to: generate a consolidated registration object associated with a plurality of different network operators, the consolidated registration object identifying a requested frequency range in a Citizens Broadband Radio Service (CBRS) network, the requested frequency range comprising a plurality of CBRS channels, at least one CBRS channel being associated with each network operators of the plurality of different network operators; and cause a Citizens Broadband Radio Service device (CBSD) to operate on the requested frequency range identified by the consolidated registration object.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram suitable for implementing a multi-operator radio access network (RAN) framework in a Citizens Broadband Radio Service (CBRS)-based wireless network according to some implementations;

FIGS. 2A–2B are sequence diagrams illustrating messages communicated between and actions taken by certain components illustrated in FIG. 1 to perform the multi-operator RAN operations according to some implementations;

FIG. 3 is a flowchart of an example method for implementing a multi-operator RAN framework in a CBRS-based wireless network according to some implementations; and

FIG. 4 is a block diagram of a computing device of an example computing system suitable for implementing examples disclosed herein.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Some wireless communication networks and systems, or particular regions of wireless spectrum, may include shared communications bands in which certain frequency bands are shared between users and/or entities. For instance, the Citizens Broadband Radio Service (CBRS) refers to a shared region of wireless spectrum that allows different entities (e.g., governmental entities, commercial entities, private entities, network operators, etc.) to dynamically utilize spectrum (e.g., certain frequency bands) rather than relying on static spectrum allocation frameworks. The CBRS spectrum is a 150 MHz wide band in the 3.5 GHz spectrum (3550–3700 MHz) and is divided into fifteen (15) 10 MHz wide channels.

The Federal Communications Commission (FCC), which manages aspects of the CBRS, has introduced three tiers of access for the CBRS: incumbent entities, Priority Access License (PAL) holding entities, and General Authorized Access (GAA) entities. CBRS access is tiered so that “non-priority” entities (e.g., businesses, network service providers, network operators, etc.) do not interfere with “priority” entities. More particularly, “incumbent” network entities typically include network entities that are associated with the government, such as military radar systems, satellite systems, etc. “PAL” network entities include network entities that have a PAL license for exclusive use in a specific geographic area. “GAA” network entities include all other network entities.

As used herein, an “incumbent” network entity and/or an “incumbent” refers to a network entity that has the highest priority (e.g., is in the highest CBRS tier), a “PAL” network entity and/or a “PAL” refers to a network entity that has intermediate priority (e.g., is in the intermediate CBRS tier) and must yield to incumbent network entities, and a “GAA” network entity and/or a “GAA” refers to a network entity that has the lower priority (e.g., is in the lower CBRS tier” and must yield to PAL network entities and incumbent network entities.

CBRS networks are implemented by Citizens Broadband Radio Service devices (CBSDs). CBSDs are hardware, such as a radio access network (RAN) base station (e.g., eNodeB (eNB), gNodeB (gNB), etc.), that facilitates communication links (e.g., transmits and/or receives data) between network entities and the CBRS network. Management of access to such CBRS networks is often handled by a managing entity, such as a Spectrum Access System (SAS). More particularly, before a network entity can access a CBRS network, the network entity must first register to use a particular CBSD with an SAS administrator (e.g., Sony, Google, Amdocs, Key Bridge Wireless, CommScope, Federated Wireless). To do so, network entities provide registration information (e.g., registration object(s)) to the SAS administrator. The registration information may include identifying information about the network entity and/or the CBSD, such as Certified Professional Installer (CPI) data associated with the network entity and/or the CBSD. For instance, CPI data may include network entity-related information (e.g., userId), CBSD-related information (e.g., cbsdSerialNumber), installation parameters (e.g., GPS coordinates of CBSD location, antenna information, etc.), and/or the like. The registration object may further include channel request data identifying at least one CBRS channel in the CBRS band on which the network entity wishes to operate (e.g., via the CBSD). It should be noted that registration object(s) are discussed in greater detail below.

Based on the registration information provided by the network entity, the SAS administer may validate and verify the registration request (e.g., CBSD identity, network entity identity, etc.). If the SAS administrator determines that the registration information is accurate and/or valid, the SAS administrator registers the CBSD and determines whether to provide a spectrum grant, which includes data identifying one or more channels in the CBRS band on which the CBSD will be authorized to operate. In some examples, the SAS administrator may determine whether to approve, modify, and/or deny the spectrum request (e.g., identified by the channel request data) based on spectrum availability, interference considerations, and/or the like. Once the spectrum grant is approved and/or a suitable channel allocation is determined, the SAS administrator provides a spectrum grant to the network entity that identifies the allocated channel(s) on which the CBSD is authorized to operate.

However, under conventional CBRS frameworks, different network entities, such as different network operators, must individually register CBSDs, which prevents multiple different network entities from operating (e.g., transmitting through) on the same CBSD. Put differently, if a first network entity is registered to operate on a CBSD, any attempt to register a second network entity to the same CBSD will be rejected by an SAS administrator. Thus, current CBRS frameworks are limited to one network entity per CBSD.

Accordingly, example aspects of the present disclosure are directed to systems and methods for implementing a multi-operator radio access network (RAN) framework that allows multiple network entities (e.g., network operators) operating in a CBRS-based wireless network to register and/or share the same CBSD. More particularly, a computing system may generate a consolidated registration object that is associated with a plurality of different network operators. The consolidated registration object may identify a requested frequency range in a CBRS network, with at least one CBRS channel in the requested frequency range being associated with each network operator of the plurality of different network operators. Furthermore, the computing system may cause a CBSD to operate on the requested frequency range identified by the consolidated registration object.

The present disclosure provides a number of technical effects and benefits, including improvements to computing technology. As one example, the present disclosure provides systems and methods for implementing a multi-operator RAN framework in a wireless network operating in the CBRS band. As such, multiple different network entities (e.g., different network operators) may share the same CBRS network infrastructure (e.g., CBSD) while simultaneously maintaining separate core networks. In this way, example aspects of the present disclosure provide for increased network connectivity while, simultaneously, reducing the costs associated with deploying CBRS network infrastructure. Furthermore, example aspects of the present disclosure provide resulting improvements to computing technology. For instance, by allowing multiple network entities (e.g., multiple network operators) to access different channels in the CBRS band via the same CBSD, example aspects of the present disclosure provide a dynamic, efficient, and scalable framework for implementing a robust CBRS-based wireless network. Furthermore, by generating consolidated registration objects for a plurality of different network operators, processing and storage requirements for the SAS and the associated SAS administrators may be directly reduced, ultimately resulting in more efficient resource use on both the system-side and the client-side. In this way, valuable computing resources that would otherwise be needed for data collection, storage, and spectrum allocation may be reserved for other tasks.

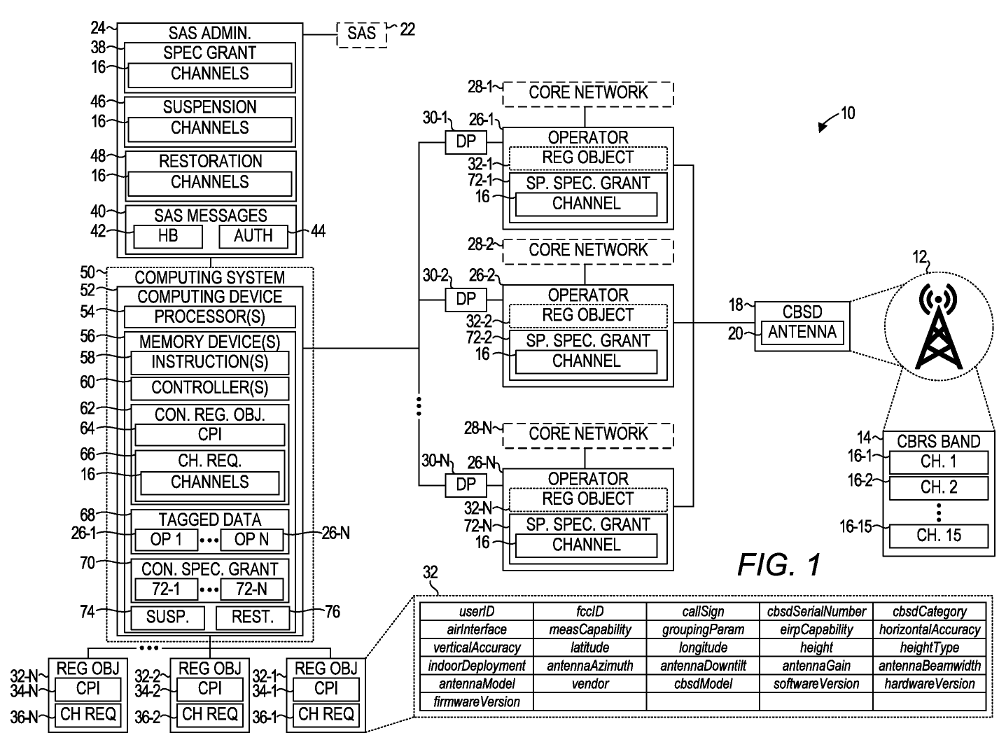

FIG. 1 is a block diagram of an environment 10 suitable for implementing a multi-operator radio access network (RAN) framework in a Citizens Broadband Radio Service (CBRS)-based wireless network. It should be understood that, as used herein, a “CBRS-based wireless network,” “CBRS-based network,” “CBRS network,” and/or the like, refers to any network, such as CBRS network 12, that operates in the Citizens Broadband Radio Service (CBRS) frequency band 14 (hereinafter, CBRS band 14). A representation of the CBRS band 14 is depicted in FIG. 1 for purposes of illustration and discussion. The CBRS band 14 is a 150 MHz wide band in the 3.5 GHz spectrum (i.e., 3550–3700 MHz) and is divided into fifteen (15) channels 16-1 – 16-15 (generally, channel(s) 16).

The CBRS network 12 may be implemented by a Citizens Broadband Radio Service device (CBSD) 18. The CBSD 18 may be any suitable device operable facilitate communication (e.g., transmit and/or receive data) in the CBRS band 14, such as, by way of non-limiting example, an eNodeB (eNB), a gNodeB (gNB), and/or the like.

The CBSD 18 may be coupled to one or more antennas 20. Each antenna 20 (or combination of antennas 20) has a radiation pattern that may be quantified by various metrics, such as, by way of non-limiting example, azimuth, gain, power, beamwidth, and/or the like. The antenna 20 may be coupled to the CBSD 18 in any suitable manner. For instance, the antenna 20 may be integrated with the CBSD 18 such that a processor device (not shown), memory (not shown), software (not shown), etc., are in a same physical package as the antenna 20. Additionally and/or alternatively, the antenna 20 may be separate from the CBSD 18 and may be coupled to the CBSD 18 via a cable or other medium via which the CBSD 18 may communicate with the antenna 20.

Before operating in the CBRS band 14 (e.g., on the CBRS network 12), the CBSD 18 must first obtain authorization to operate on one of more of the channels 16 of the CBSD band 14 via the Spectrum Access System (SAS) 22. More particularly, the SAS 22 is a cloud-based spectrum management system operable to control access to the CBRS network 12 by allocating and coordinating spectrum usage in the CBSD band 14. Those having ordinary skill in the art will understand that SAS-related services may, in some examples, be provided by an SAS administrator 24. It should be noted that, because the SAS administrator 24 is responsible for providing the SAS-related services of the SAS 22, functionality implemented by the SAS 22 may be attributed to the SAS administrator 24 generally.

As noted herein, the SAS administrator 24 may facilitate the management of radio frequency spectrum in the CBSD band 14 and coordinate the allocation of available spectrum resources, such as access to transmit and/or receive data in one of the channels 16. For instance, one responsibility of the SAS administrator 24 is to manage network access (e.g., to CBRS network 12) to ensure non-incumbent entities (e.g., PAL entities, GAA entities, etc.) do not interfere with incumbent entities. As noted above, an “incumbent” entity and/or an “incumbent” refers to a network entity that has the highest priority (e.g., is in the highest CBRS tier), a “PAL” entity and/or a “PAL” refers to a non-incumbent network entity that has intermediate priority (e.g., is in the intermediate CBRS tier) and must yield to incumbent network entities, and a “GAA” entity and/or a “GAA” refers to a non-incumbent network entity that has the lowest priority (e.g., is in the lower CBRS tier” and must yield to PAL entities and incumbent entities.

As used herein, a “network entity” refers to any type or manner of entity that requests access to a network (e.g., CBRS network 12) or a region of frequency within a network (e.g., CBRS band 14). For example, network entities may include and/or otherwise refer to network service providers (e.g., internet service providers, wireless telephone service providers, geolocation services, etc.), governmental organizations (e.g., police, military, first responders, etc.), medical personnel, private organizations, a businesses, users (e.g., subscribers to network service providers), etc. The term “network entity” may also be used interchangeably to refer to device(s) used by the above-mentioned entities, such as, by way of non-limiting example, user devices (e.g., smartphones, laptops, tables, etc.), network devices (e.g., network nodes, endpoint devices, routers, modems, Cable Modem Termination Systems (CMTSs), etc.), network functions (e.g., SASs, etc.), and/or the like.

One example of a non-incumbent network entity is a network operator, such as network operators 26-1 – 26-N (generally, network operator(s) 26). Network operators 26 may be network entities that deploy, manage, operate, etc., CBRS-based networks, such as the CBRS network 12. By way of non-limiting illustrative example, a network operator 26 may be an enterprise (e.g., private business), a telecommunications carrier (e.g., network service provider), and/or the like.

As shown in FIG. 1, each network operator 26-1 – 26-N may have an associated core network 28-1 – 28-N. Each network operator 26-1 – 26-N may likewise be associated with a particular domain proxy (DP) 30-1 – 30-N. That is, each network operator 26 may have a different core network 28 and/or a different domain proxy (DP) 30. Each core network 28 may be any suitable backend computing system that manages and/or control network-related functions for the corresponding network operator 26. Furthermore, each domain proxy 30 may be any suitable middleware computing system acting as an intermediary between the corresponding network operator 26 and another domain and/or server, such as the SAS 22 (e.g., via SAS administrator 24), a CBSD 18, and/or the like.

Before accessing the CBRS network 12, the CBSD 18 must first register with, and obtain authorization from, the SAS 22 (e.g., via SAS administrator 24). For instance, as an illustrative overview of a SAS registration process, suppose network operator 26-1 wishes to operate on channel 16-1 of the CBRS band 14 via the CBSD 18. To register the CBSD 18, the network operator 26-1 may provide a SAS registration object 32-1 to the SAS administrator 24. The network operator 26-1 may provide the SAS registration object 32-1 directly to the SAS administrator 24. Additionally and/or alternatively, the network operator 26-1 may provide the SAS registration object 32-1 indirectly to the SAS administrator 24, such as via the corresponding domain proxy 30-1.

It should be understood that, as used herein, a “registration object” refers to any mechanism operable to maintain the relevant registration information associated with a network operator 26 and/or the CBSD 18, such as a record, data entry, entry in a file, and/or the like, and does not imply any particular type of storage structure.

In some examples, the SAS registration object 32-1 may include registration information and identifying information such as, by way of non-limiting example, Certified Professional Installer (CPI) data 34-1 associated with the network operator 26-1 and/or the CBSD 18, channel request data 36-1 identifying at least one CBRS channel 16 as a requested frequency range in the CBRD band 14, and/or the like. For instance, the CPI data 34-1 may include a plurality of data fields generated by the network operator 26-1 and/or the CBSD 18. The plurality of data fields may include identifying information about the network operator 26-1 and the CBSD 18, such as, by way of non-limiting example, data identifying the CBSD 18 (e.g., fccID cbsdSerialNumber, cbsdCategory, airInterface, measCapability, groupingParam, cbsdModel, vendor, softwareVersion, hardwareVersion, firmwareVersion), data identifying the network operator 26-1 (e.g., userID, callSign), data related to the antenna 20 (e.g., eirpCapability, horizontalAccuracy, verticalAccuracy, height, heightType, antennaAzimuth, antennaDowntilt, antennaGain, antennaBeamwidth, antennaModel), data related to a physical location of the CBSD 18 (e.g., latitude, longitude, indoorDeployment), and/or the like. The channel request data 36-1 may identify a portion of the CBRS band 14 in which the network operator 26-1 wishes to operate, such as, in the example described above, data identifying channel 16-1 of the CBRS band 14.

The SAS administrator 24 may process the SAS registration object 32-1 associated with the CBSD 18 to verify and/or validate the registration request. If the SAS administrator 24 determines that the registration information (e.g., CPI data 34-1) is accurate and/or valid, the SAS administrator 24 registers the CBSD 18 and determines whether to provide a spectrum grant 38, which includes data identifying one or more channels 16 in the CBRS band 14 on which the CBSD 18 is authorized to operate. In some examples, the spectrum grant 38 may correspond to the channel 16 of the CBRS band 14 that was identified by the channel request data 36-1. In some examples, the spectrum grant 38 may correspond to a different channel 16 of the CBRS band 14 that was identified by the channel request data 36-1.

Once the SAS registration object 32-1 is processed and/or the spectrum grant 38 is generated by the SAS administrator 24, the SAS administrator 24 may provide the spectrum grant 38 to the network operator 26-1. In some examples, the SAS administrator 24 may directly provide the spectrum grant 38 to the network operator 26-1. Additionally and/or alternatively, in some examples, the SAS administrator 24 may indirectly provide the spectrum grant 38 to the network operator 26-1, such as via the corresponding domain proxy 30-1. Subsequent to and/or simultaneously with providing the spectrum grant 38, the SAS administrator 24 may exchange additional SAS messages 40 with the network operator 26-1 and/or the CBSD 18, such as SAS heartbeat message(s) 42, SAS authorization messages 44, and/or the like.

Subsequent to the CBSD 18 obtaining the spectrum grant 38 from the SAS administrator 24, the CBSD 18 may begin operating on the channel 16 identified by the spectrum grant 38. The SAS administrator 24 may continue to monitor the CBSD 18 and/or the CBRD network 12 and may, in some situations, suspend and/or revoke the access of the CBSD 18 (and/or other non-incumbent entities) to the CBRS network 12. In some examples, the SAS administrator 24 may suspend and/or revoke access of the CBSD 18 (and/or other non-incumbent entities) to the CBRS network 12 based on incumbent activity detected by the SAS administrator 24. For instance, in some examples, the SAS administrator 24 may determine that an incumbent network entity requires access to one or more of the channels 16 in the CBRS band 14 of the CBRS network 12. In such examples, the SAS administrator 24 may generate a spectrum suspension notification 46 (e.g., identifying one or more channels 16 in the CBSD band 14) that is configured to cause the CBSD 18 and/or other non-incumbent entity to cease operations in a particular portion of the CBSD band 14 until a corresponding restoration notification 48 is received.

For instance, to continue the illustrative example described above, the SAS administrator 24 may determine that an incumbent entity requires access to the channel 16-1. In response, the SAS administrator 24 may generate a spectrum suspension notification 46 (e.g., identifying channel 16-1) and provide the spectrum suspension notification 46 to the CBSD 18, the network operator 26-1, the domain proxy 30-1, and/or the like, that causes the CBSD 18 to suspend operations on channel 16-1. Once the SAS administrator 24 determines that the incumbent entity no longer requires access to the channel 16-1, the SAS administrator 24 may generate a restoration notification 48 (e.g., identifying channel 16-1) and provide the restoration notification 48 to the CBSD 18, the network operator 26-1, the domain proxy 30-1, and/or the like, that causes the CBSD 18 to resume operations on channel 16-1.

However, under conventional CBRS frameworks, each network operator 26 must individually register the CBSD 18 with the SAS administrator 24, which prevent multiple network operators 26 from registering and/or using the same CBSD 18. For instance, using the illustrative example described above, none of the remaining network operators 26-2 – 26-N would be allowed (e.g., by the SAS administrator 24) to register and/or use the CBSD 18 after providing the spectrum grant 38 to the network operator 26-1.

Accordingly, to address this limitation of conventional CBRS frameworks, example aspects of the present disclosure provide a computing system 50 that is operable to implement a multi-operator RAN framework that allows a plurality of network operators (e.g., network operators 26-1 – 26-N) operating on the CBRS network 12 to register and/or use the same CBSD (e.g., CBSD 18). It should be understood that, as used herein, a “multi-operator RAN” framework and/or “MoRAN” framework refers to a network architecture allowing multiple network operators (e.g., network operators 26-1 – 26-N) to share CBRS network infrastructure (e.g., CBSD 18) while maintaining separate core networks (e.g., core networks 28-1 – 28-N).

As shown, the computing system 50 includes one or more computing devices 52. It should be understood that example aspects of the present disclosure are disclosed and/or depicted herein as being implemented by a single component on a single computing device (e.g., computing device 52) for purposes of illustration and discussion. However, in some examples, the functionality described herein may be distributed across multiple components on multiple computing devices in the computing system 50. Moreover, while solely for purposes of illustration and discussion, various components will be illustrated as executing on the computing device 52. It is noted that the components could execute in different operating environments including, by way of non-limiting example, virtual machine environment(s), cloud computing environment(s), and/or the like.

The computing device 52 may include a processor device 54. The processor device 54 may include any computing or electronic device(s) capable of executing software instructions to implement the functionality described herein. For example, the processor device 54 may be one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The processor device 54 may be a single processor device and/or a plurality of processor devices that are operatively connected, for instance, in a parallel configuration.

The computing device 52 may further include a memory 56. The memory 56 may be communicatively coupled to the processor device 54. The memory 56 may include executable instructions 58 that, when executed, cause the processor device 54 to perform operations, such as any of the operations described herein. In some examples, the memory 56 includes a controller 60 operable to implement the functionality described herein. Because the controller 60 is a component of the computing system 50 and/or the computing device 52, functionality implemented by the controller 60 may be attributed to the computing system 50 and/or the computing device 52 generally. Moreover, in examples where the controller 60 includes software instructions (e.g., instructions 58) that program the processor device 54 to carry out the functionality described herein, functionality implemented by the controller 60 may be attributed to the processor device 54, the computing system 50, and/or to the computing device 52 generally.

The memory 56 may be or otherwise include any device(s) capable of storing data, including, but not limited to, volatile memory (random access memory, etc.), non-volatile memory, storage device(s) (e.g., hard drive(s), solid state drive(s), etc.). For example, the memory device 56 may include one or more non-transitory computer-readable storage mediums, such as such as a Read Only Memory (ROM), Programmable Read Only Memory (PROM), Erasable Programmable Read Only Memory (EPROM), and flash memory, a USB drive, a volatile memory device such as a Random Access Memory (RAM), an internal or external hard disk drive (HDD), floppy disks, a blue-ray disk, or optical media such as CD ROM discs and DVDs, and combinations thereof. However, examples of the memory device 56 are not limited to the above description, and the memory device 56 may be realized by other various devices and structures as would be understood by those having ordinary skill in the art.

As noted above, the computing system 50 may be configured to implement a multi-operator RAN framework that is configured to facilitate communication between each network operator 26-1 – 26-N and the CBRS network 12 via the CBSD 18 (e.g., each network operator 26-1 – 26-N communicates over at least one CBRS channel 16 via the CBSD 18). As a general overview, to address the operator-based SAS restrictions described above, the computing system 50 may generate a consolidated registration object 62 that is associated with a plurality of different network operators, such as the network operators 26-1 – 26-N. The consolidated registration object 62 may be similar to, include similar information as, have a similar structure as, etc., the SAS registration objects 32 described above. For instance, in some examples, the consolidated registration object 62 may include CPI data 64 (e.g., similar to the CPI data 34 described above). The consolidated registration object 62 may further include consolidated channel request data 66 (e.g., similar to the channel request data 36 described above) identifying a requested frequency range in the CBRS network 12 (e.g., identifying a plurality of channels 16 in the CBRS band 14). The consolidated channel request data 66 may include a plurality of channels 16 in the CBRS band 14, with at least one channel 16 (e.g., in the consolidated channel request data 66) being associated with each network operator 26-1 – 26-N of the plurality of different network operators 26. Furthermore, as described in greater detail below, the computing system 50 may cause the CBSD 18 to operate on the requested frequency range (e.g., consolidated channel request data 66) identified by the consolidated registration object 62.

More particularly, in some examples, the computing system 50 may obtain a SAS registration object, such as the SAS registration objects 32-1 – 32-N, from each network operator 26-1 – 26-N of the plurality of different network operators 26. SAS registration objects 32-1 – 32-N may be obtained directly from the corresponding network operator 26-1 – 26-N and/or from the particular domain proxy 30-1 – 30-N associated with the corresponding network operator 26-1 – 26-N. As described above, the SAS registration object 32-1 may include CPI data 34-1 associated with the network operator 26-1 and channel request data 36-1 identifying at least one channel 16 in the requested frequency range (e.g., consolidated channel request data 66), the SAS registration object 32-2 may include CPI data 34-2 associated with the network operator 26-2 and channel request data 36-2 identifying at least one channel 16 in the requested frequency range (e.g., consolidated channel request data 66), … and the SAS registration object 32-N may include CPI data 34-N associated with the network operator 26-N and channel request data 36-N identifying at least one channel 16 in the requested frequency range (e.g., consolidated channel request data 66). In such examples, the computing system 50 may generate the consolidated registration object 62 based on the SAS registration object 32-1 – 32-N received from each network operator 26 of the plurality of network operators 26-1 – 26-N.

As an illustrative non-limiting example, suppose network operator 26-1 wishes to operate on channel 16-1, and network operator 26-2 wishes to operate on channel 16-2. In such an example, he computing system 50 may obtain SAS registration object 32-1 from network operator 26-1 (and/or domain proxy 30-1), which includes CPI data 34-1 identifying the network operator 26-1 and channel request data 36-1 identifying channel 16-1. Likewise, the computing system 50 may obtain SAS registration object 32-2 from network operator 26-2 (and/or domain proxy 30-2), which includes CPI data 34-2 identifying the network operator 26-2 and channel request data 36-2 identifying channel 16-2. The computing system 50 may generate the consolidated registration object 62 based on the SAS registration object 32-1 (e.g., obtained from network operator 26-1) and the SAS registration object 32-2 (e.g., obtained from network operator 26-2). That is, the computing system 50 may generate a consolidated registration object 62 that includes CPI data 64 (e.g., without network operator-specific CPI data from the SAS registration objects 32-1 – 32-2) and consolidated channel request data 66 (e.g., identifying channels 16-1 – 16-2 as the requested frequency range in the CBRS network 12).

Subsequent to obtaining the SAS registration objects 32 from each network operator 26, the computing system 50 may generate tagged operator data 68 that correlates each SAS registration object 32-1 – 32-N to a particular network operator 26-1 – 26-N of the plurality of different network operators 26. The tagged operator data 68 may have any suitable format and/or structure. Furthermore, the computing system 50 may further store the tagged operator data 68 in a memory of the computing system 50, such as the memory device 56 and/or any other suitable data storage device.

For instance, to continue the illustrative example introduced above, subsequent to obtaining the SAS registration object 32-1 from the network operator 26-1 and the SAS registration object 32-2 from the network operator 26-2, the computing system 50 may generate tagged operator data 68—which correlates the SAS registration object 32-1 with the network operator 26-1 and the SAS registration object 32-2 with the network operator 26-2—and may store the tagged operator data 68 in the memory device 56.

The computing system 50 may provide the consolidated registration object 62 to the SAS administrator 24. Because the consolidated registration object 62 originates from the computing system 50, the consolidated registration object 62 appears as if it is coming from one network entity (e.g., computing system 50) instead of the plurality of different network operators 26.

Subsequent to providing the consolidated registration object 62 to the SAS administrator 24, the computing system 50 may obtain a consolidated spectrum grant 70 from the SAS administrator 24. In examples where the SAS administrator 24 approves the consolidated registration object 62, the consolidated spectrum grant 70 may identify the plurality of CBRS channels 16 of the requested frequency range identified by the consolidated channel request (e.g., consolidated channel request data 66).

For instance, to continue the illustrative example described above, the consolidated spectrum grant 70 may identify the channel 16-1 (e.g., identified by channel request data 36-1) and the channel 16-2 (e.g., identified by channel request data 36-2).

Subsequent to obtaining the consolidated spectrum grant 70 from the SAS administrator 24, the computing system 50 may determine specific spectrum grants 72-1 – 72-N (generally, “specific spectrum grant(s) 72”) for each network operator 26-1 – 26-N of the plurality of different network operators 26. A specific spectrum grant 72 may correspond to a portion of the consolidated spectrum grant 70 that includes the at least one channel 16 associated with the corresponding network operator 26. In some examples, each specific spectrum grant 72 may be determined based on the tagged operator data 68 (e.g., correlating each SAS registration object 32-1 – 32-N to a particular network operator 26-1 – 26-N of the plurality of different network operators 26). The computing system 50 may provide each specific spectrum grant 72-1 – 72-N to the corresponding network operator 26-1 – 26-N and/or to the particular domain proxy 30-1 – 30-N associated therewith.

For instance, to continue the illustrative example described above, the computing system 50 may determine that the consolidated spectrum grant 70 includes spectrum grants associated with channel 16-1 and channel 16-2. The computing system 50 may determine a specific spectrum grant 72-1 for the network operator 26-1 that corresponds to channel 16-1 based, for instance, on tagged operator data 68 linking the network operator 26-1 to channel 16-1. The computing system 50 may further determine a specific spectrum grant 72-2 for the network operator 26-2 that corresponds to channel 16-2 based, for instance, on tagged operator data 68 linking the network operator 26-2 to channel 16-2. The computing system 50 may provide the specific spectrum grant 72-1 to the network operator 26-1 (and/or to the domain proxy 30-1) and may further provide the specific spectrum grant 72-2 to the network operator 26-2 (and/or to the domain proxy 30-2).

Additionally, in some examples, the computing system 50 may receive a SAS message 40, such as a SAS heartbeat message 42 and/or a SAS authorization message 44, from the SAS administrator 24 that is associated with a particular channel 16 of the plurality of channels 16 identified by the consolidated spectrum grant 70. In such examples, the computing system 50 may determine a particular network operator 26-1 – 26-N of the plurality of different network operators 26 is an intended recipient of the SAS message 40 based on the particular channel 16 associated with the SAS message 40. For instance, the computing system 50 may determine which network operator 26 is the intended recipient based on the tagged operator data 68. After identifying the intended recipient, the computing system 50 may provide the SAS message 40 to the particular network operator 26 (and/or the corresponding domain proxy 30) that is the intended recipient of the SAS message 40.

For instance, to continue the illustrative example described above, the computing system 50 may receive a SAS message 40 associated with channel 16-1. The computing system 50 may determine that the network operator 26-1 is the intended recipient of the SAS message 40 based, for instance, on tagged operator data 68 linking the network operator 26-1 to channel 16-1. The computing system 50 may provide the SAS message 40 to the network operator 26-1 (and/or to the domain proxy 30-1).

In some examples, such as when incumbent activity is detected by the SAS administrator 24, the computing system 50 may receive a spectrum suspension notification 46 associated with a particular channel 16 of the plurality of channels 16 identified by the consolidated spectrum grant 70. The computing system 50 may determine that the particular channel 16 is associated with a particular network operator 26-1 – 26-N of the plurality of different network operators 26 based, for instance, on the specific spectrum grant 72 associated with the particular network operator 26-1 – 26-N, the tagged operator data 68 associated with the particular network operator 26-1 – 26-N, and/or the like. In such examples, the computing system 50 may generate and provide suspension instructions 74 to the particular network operator 26 (and/or the corresponding domain proxy 30) that cause the CBSD 18 to cease operating on the particular channel 16 associated with the suspension notification 46.

For instance, to continue the illustrative example described above, the computing system 50 may receive a spectrum suspension notification 46 associated with channel 16-1. The computing system 50 may determine that the channel 16-1 is associated with the network operator 26-1 based, for instance, on the specific spectrum grant 72-1, the tagged operator data 68 linking the network operator 26-1 to channel 16-1, and/or the like. The computing system 50 may provide suspension instructions 74 to the network operator 26-1 (and/or to the domain proxy 30-1) that cause the CBSD 18 to cease operating on channel 16-1.

In some examples, once the SAS administrator 24 determines that the incumbent entity no longer requires access to the particular channel 16 associated with the spectrum suspension notification 46, the computing system 50 may receive a spectrum restoration notification 48 associated with the particular channel 16. The computing system 50 may determine that the particular channel 16 is associated with a particular network operator 26-1 – 26-N of the plurality of different network operators 26 based, for instance, on the specific spectrum grant 72 associated with the particular network operator 26-1 – 26-N, the tagged operator data 68 associated with the particular network operator 26-1 – 26-N, the spectrum suspension notification 46, the suspension instructions 74, and/or the like. In such examples, the computing system 50 may generate and provide restoration instructions 76 to the particular network operator 26 (and/or the corresponding domain proxy 30) that cause the CBSD 18 to resume operating on the particular channel 16 associated with the restoration notification 48.

For instance, to continue the illustrative example described above, the computing system 50 may receive a restoration notification 48 associated with channel 16-1. The computing system 50 may determine that the channel 16-1 is associated with the network operator 26-1 based, for instance, on the specific spectrum grant 72-1, the tagged operator data 68 linking the network operator 26-1 to channel 16-1, the spectrum suspension notification 46, the suspension instructions 74, and/or the like. The computing system 50 may provide restoration instructions 76 to the network operator 26-1 (and/or to the domain proxy 30-1) that cause the CBSD 18 to resume operating on channel 16-1.

It should be understood that FIG. 1 was illustratively described with reference to two network operators 26-1 – 26-2 for purposes of illustration and discussion. However, those having ordinary skill in the art, using the disclosures provided herein, will understand that the computing system 50 may operate as a multi-operator RAN registrar for any number network operators 26 without deviating from the scope of the present disclosure.

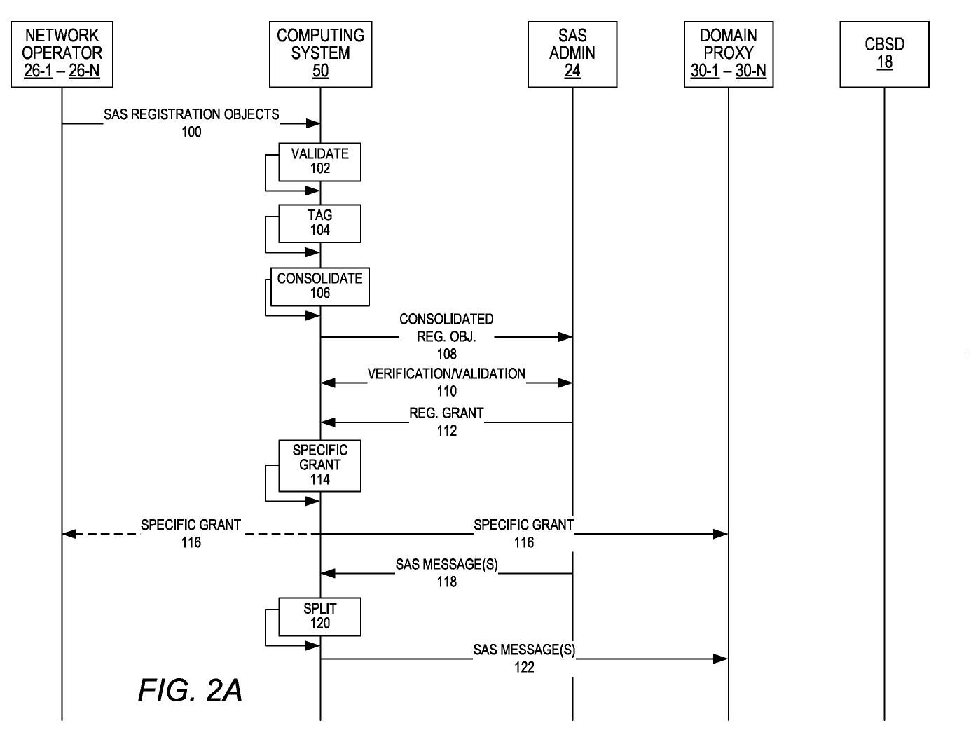

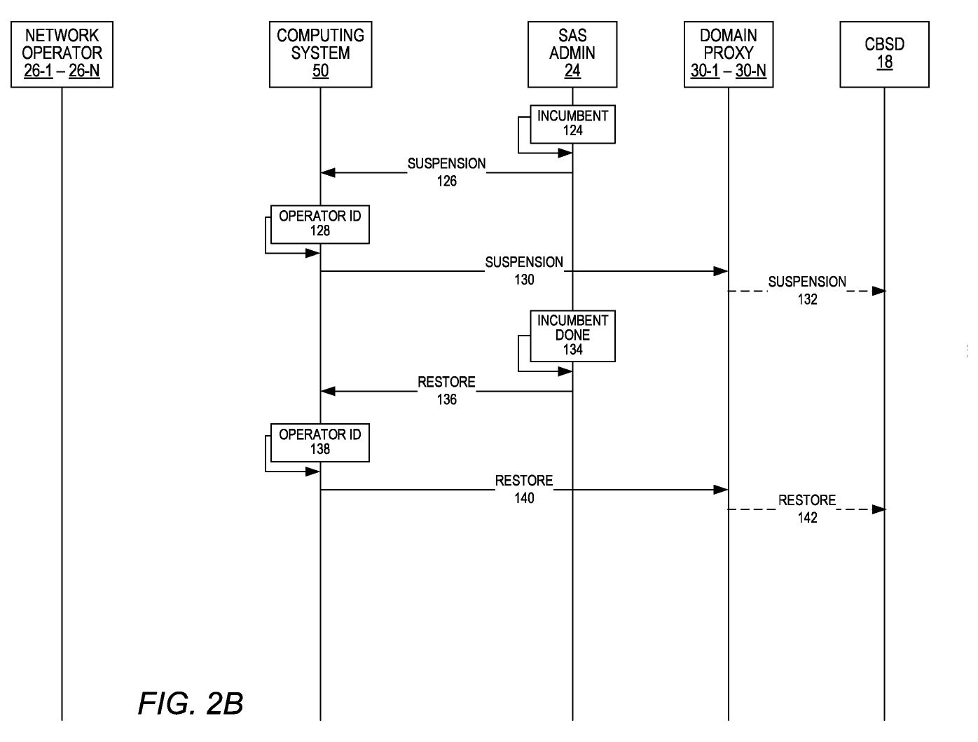

FIGS. 2A–2B depict sequence diagrams illustrating messages communicated between and actions taken by certain components illustrated in FIG. 1 to perform the multi-operator RAN operations described herein according to some implementations of the present disclosure. FIGS. 2A–2B will be discussed in conjunction with FIG. 1.

Referring to FIG. 2A, the computing system 50 obtains SAS registration objects 32 from each network operator 26-1 – 26-N of a plurality of different network operators 26 (FIG. 2A, step 100). The computing system 50 process the registration objects 32 and validate that the corresponding CPI information 34 is correct (FIG. 2A, step 102). Once validated, the computing system 50 generates tagged operator data 68 correlating each SAS registration object 32 to a particular network operator 26-1 – 26-N of the plurality of different network entities 26 (FIG. 2A, step 104).

The computing system 50 generates a consolidated registration object 62 based on the SAS registration object 32 received from each network operator 26-1 – 26-N of the plurality of different network operators 26, which includes consolidated channel request data 66 identifying a requested frequency range (e.g., based on the channel request data 36 of the registration objects 32) (FIG. 2A, step 106). Subsequently, the computing system 50 provides the consolidated registration object 62 to a SAS administrator 24 (FIG. 2A, step 108).

The computing system 50 exchanges standard verification and validation messages with the SAS administrator 24 (FIG. 2A, step 110) and obtains a consolidated spectrum grant 70 identifying the plurality of CBRS channels 16 included in the consolidated channel request data 66 of the consolidated registration object 62 (FIG. 2A, step 112). For each network operator 26-1 – 26-N, the computing system 50 determines a specific spectrum grant 72-1 – 72-N that corresponds to a portion of the consolidated spectrum grant 70 that includes the CBRS channel 16 associated with the corresponding network operator 26 (FIG. 2A, step 114). The computing system 50 provides the specific spectrum grant 72-1 – 72-N to each network operator 26-1 – 26-N of the plurality of different network operators 26 (FIG. 2A, step 116).

The computing system 50 receives a SAS message 40 (e.g., SAS heartbeat message 42, SAS authorization message 44) that is associated with a particular CBRS channel 16 (e.g., of the plurality of CBRS channels 16 identified by the consolidated spectrum grant 72) (FIG. 2A, step 118). The computing system 50 determines which particular network operator 26-1 – 26-N is the intended recipient of the SAS message 40 based on the particular CBRS channel 16 associated with the SAS message 40 (FIG. 2A, step 120) and provides the SAS message 40 to the particular domain proxy 30-1 – 30-N associated with the particular network operator 26-1 – 26-N that is the intended recipient (FIG. 2A, step 122).

Referring now to FIG. 2B, the SAS administrator 24 detects incumbent activity associated with a particular CBRS channel 16 and generates a corresponding spectrum suspension notification 46 based on detected the incumbent activity (FIG. 2B, step 124). The computing system 50 receives the spectrum suspension notification 46 (FIG. 2B, step 126) and determines that the particular CBRS channel 16 (e.g., identified by the spectrum suspension notification 46) is associated with a particular network operator 26-1 – 26-N based, for instance, on the tagged operator data 68 associated with the particular network operator 26-1 – 26-N, the corresponding specific spectrum grant 72 associated with the particular network operator 26-1 – 26-N, and/or the like (FIG. 2B, step 128). The computing system 50 generates and provides suspension instructions 74 to the particular domain proxy 30-1 – 30-N associated with the particular network operator 26-1 – 26-N (FIG. 2B, step 130), which cause the CBSD 18 to cease operating on the particular CBRS channel 16 associated with the suspension instructions 74 (FIG. 2B, step 232).

The SAS administrator 24 determines that the incumbent entity associated with the incumbent activity no longer requires access to the particular channel 16 associated with the spectrum suspension notification 46 and generates a corresponding restoration notification 48 (FIG. 2B, step 134). The computing system 50 receives the restoration notification 48 (FIG. 2B, step 136) and determines that the particular CBRS channel 16 (e.g., identified by the restoration notification 48) is associated with a particular network operator 26-1 – 26-N based, for instance, on the tagged operator data 68 associated with the particular network operator 26-1 – 26-N, the corresponding specific spectrum grant 72 associated with the particular network operator 26-1 – 26-N, the spectrum suspension notification 46, the suspension instructions 74, and/or the like (FIG. 2B, step 138). The computing system 50 generates and provides restoration instructions 76 to the particular domain proxy 30-1 – 30-N associated with the particular network operator 26-1 – 26-N (FIG. 2B, step 140), which cause the CBSD 18 to resume operation on the particular CBRS channel 16 associated with the suspension instructions 74 and/or the restoration instructions 76 (FIG. 2B, step 142).

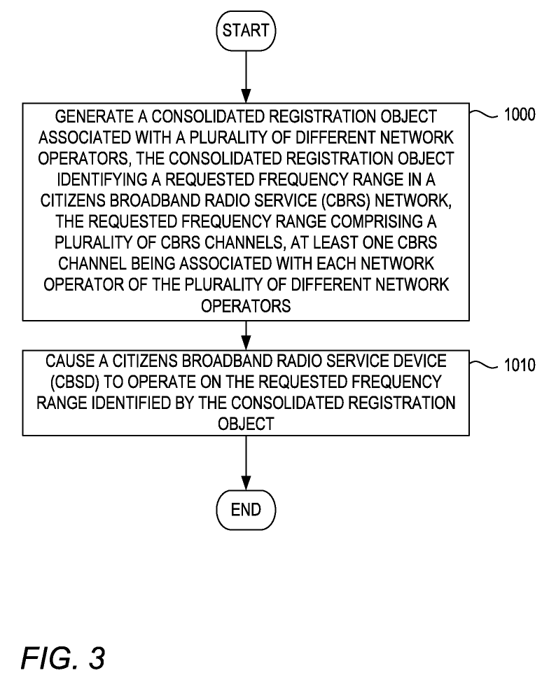

FIG. 3 depicts a flowchart of an example method for implementing a multi-operator RAN framework in a CBRS-based wireless network according to some implementations. FIG. 3 will be discussed in conjunction with FIG. 1. The computing system 50 generates a consolidated registration object 62 associated with a plurality of different network operators 26 (e.g., network operators 26-1 – 26-N) (FIG. 3, block 1000). The consolidated registration object 62 identifies a requested frequency range in a Citizens Broadband Radio Service (CBRS) network, such as the CBRS network 12. The requested frequency range includes a plurality of CBRS channels (e.g., channels 16-1 – 16-15). At least one CBRS channel (e.g., channel 16-1 – 16-15) is associated with each network operator 26-1 – 26-N of the plurality of different network operators 26. The computing system 50 causes a Citizens Broadband Radio Service device (CBSD) (e.g., CBSD 18) to operate on the requested frequency range identified by the consolidated registration object 62 (FIG. 3, block 1010).

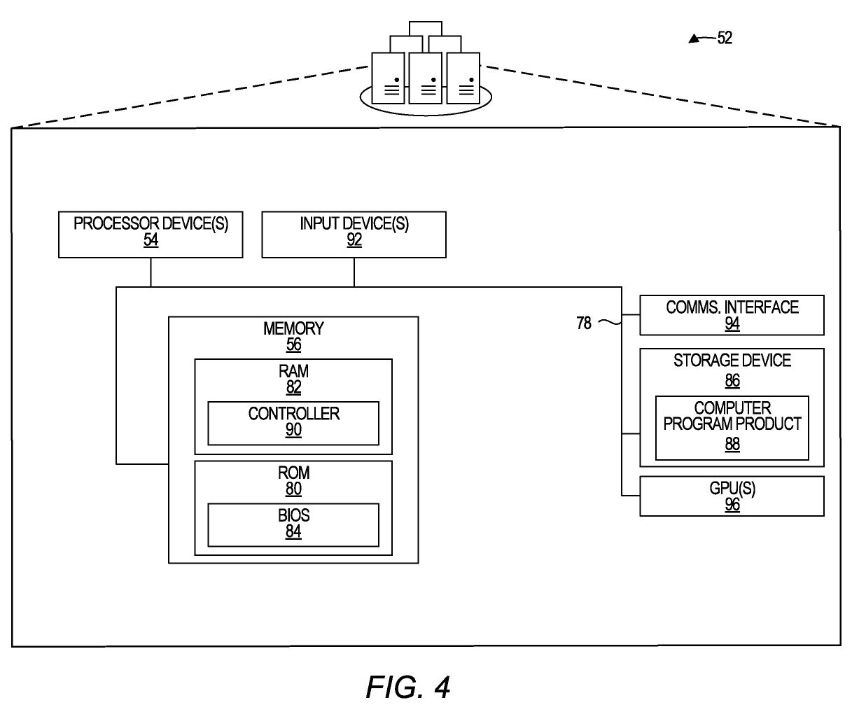

FIG. 4 depicts a block diagram of an example computing device of the computing system 50 (e.g., described above with reference to FIGS. 1–3), such as the computing device 52, suitable for implementing the examples disclosed herein according to some implementations. The computing device 52 may be any suitable computing device operable to perform the multi-operator RAN operations described herein for the computing system 50.

The computing device 52 may include any computing and/or electronic device capable of including firmware, hardware, and/or executing software instructions to implement the functionality described herein, such as a computer server, computing device, and/or the like. The computing device 52 includes processor device(s) 54, a system memory (e.g., memory 56), and a system bus 78. The system bus 78 provides an interface for system components including, but not limited to, the memory 56 and the processor device 54. The processor device(s) 54 may be any commercially available or proprietary processor.

The system bus 78 may be any of several types of bus structures that may further interconnect to a memory bus (with or without a memory controller), a peripheral bus, and/or a local bus using any of a variety of commercially available bus architectures. The memory 56 may include non-volatile memory 80 (e.g., read-only memory (ROM), erasable programmable read-only memory (EPROM), electrically erasable programmable read-only memory (EEPROM), etc.), and volatile memory 82 (e.g., random-access memory (RAM)). A basic input/output system (BIOS) 84 may be stored in the non-volatile memory 80 and may include the basic routines that help to transfer information between elements within the computing device 52. The volatile memory 82 may also include a high-speed RAM, such as static RAM, for caching data.

The computing device 52 may further include or be coupled to a non-transitory computer-readable storage medium, such as a storage device 86, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 86 and other drives associated with computer-readable media and computer-usable media may provide non-volatile storage of data, data structures, computer-executable instructions, and the like.

A number of modules can be stored in the storage device 86 and in the volatile memory 82, including an operating system and one or more program modules, which may implement the functionality described herein in whole or in part. All or a portion of the examples may be implemented as a computer program product 88 stored on a transitory or non-transitory computer-usable or computer-readable storage medium, such as the storage device 86, which includes complex programming instructions, such as complex computer-readable program code, to cause the processor device 54 to carry out the steps described herein. Thus, the computer-readable program code may comprise software instructions for implementing the functionality of the examples described herein when executed on the processor device 54. The processor device 54, in conjunction with a controller 90 (e.g., controller 60) in the volatile memory 82, may serve as a controller and/or or a control system for the computing device 52 and/or the computing system 50 that is to implement the functionality described herein.

An operator (e.g., user) may also be able to enter one or more configuration commands through one or more input device(s) 92, such as a keyboard (not illustrated), a pointing device such as a mouse (not illustrated), or a touch-sensitive surface such as a display device. Such input devices 92 may be connected to the processor device 54 through an input interface (not shown) coupled to the system bus 78 but can be connected through other interfaces such as a parallel port, an Institute of Electrical and Electronic Engineers (IEEE) 1394 serial port, a Universal Serial Bus (USB) port, an IR interface, and/or the like.

The computing device 52 may also include a number of communication interfaces, such as communication interface 94, that are suitable for communicating with a network (or devices connected thereto) as appropriate or desired. For instance, in some examples, the computing device 52 may be operable to communicate with one or more downstream computing devices (e.g., domain proxy(s) 30-1 – 30-N) and/or one or more upstream computing devices (e.g., SAS 22) via the communication interface 94. The computing device 52 may further include one or more GPUs 96.

Individuals will recognize improvements and modifications to the preferred examples of the disclosure. All such improvements and modifications are considered within the scope of the concepts disclosed herein and the claims that follow.

What is claimed is:

1. A method, comprising:
generating, by a computing system comprising one or more computing devices, a consolidated registration object associated with a plurality of different network operators, the consolidated registration object identifying a requested frequency range in a Citizens Broadband Radio Service (CBRS) network, the requested frequency range comprising a plurality of CBRS channels, at least one CBRS channel being associated with each network operator of the plurality of different network operators; and
causing, by the computing system, a Citizens Broadband Radio Service device (CBSD) to operate on the requested frequency range identified by the consolidated registration object.

2. The method of claim 1, wherein generating the consolidated registration object comprises:
from each network operator of the plurality of different network operators:
obtaining, by the computing system, a Spectrum Access System (SAS) registration object; and
generating, by the computing system, the consolidated registration object based on the SAS registration object obtained from each network operator of the plurality of different network operators.

3. The method of claim 2, wherein each SAS registration object comprises:
Certified Professional Installer (CPI) data associated with the network operator; and
channel request data identifying at least one CBRS channel of the plurality of CBRS channels of the requested frequency range.

4. The method of claim 3, wherein the consolidated registration object comprises consolidated channel request data identifying the requested frequency range in the CBRS network, the consolidated channel request data comprising the channel request data from each SAS registration object.

5. The method of claim 2, further comprising:
subsequent to obtaining the SAS registration object from each network operator, generating, by the computing system, tagged operator data correlating each SAS registration object to a particular network operator of the plurality of different network operators; and
storing, by the computing system, the tagged operator data in a memory of the computing system.

6. The method of claim 1, wherein causing the CBSD to operate on the requested frequency range identified by the consolidated registration object comprises:
providing, by the computing system, the consolidated registration object to a Spectrum Access System (SAS) administrator; and
subsequent to providing the consolidated registration object to the SAS administrator, obtaining, by the computing system from the SAS administrator, a consolidated spectrum grant identifying the plurality of CBRS channels of the requested frequency range.

7. The method of claim 6, wherein each network operator of the plurality of different network operators is associated with a particular domain proxy that is communicatively coupled to the CBSD, the method further comprising:
for each network operator:
determining, by the computing system, a specific spectrum grant for the network operator, the specific spectrum grant corresponding to a portion of the consolidated spectrum grant that includes the at least one CBRS channel associated with the network operator; and
providing, by the computing system, the specific spectrum grant to the particular domain proxy associated with the network operator.

8. The method of claim 7, further comprising:
receiving, by the computing system from the SAS administrator, a spectrum suspension notification associated with a particular CBRS channel of the plurality of CBRS channels identified by the consolidated spectrum grant;
determining, by the computing system, that the particular CBRS channel is associated with a particular network operator based on the specific spectrum grant associated with the particular network operator; and
providing, by the computing system, suspension instructions to the particular domain proxy associated with the particular network operator, the suspension instructions causing the CBSD to cease operating on the particular CBRS channel associated with the spectrum suspension notification.

9. The method of claim 8, wherein the SAS administrator provides the spectrum suspension notification to the computing system based on incumbent activity detected by the SAS administrator.

10. The method of claim 6, wherein each network operator of the plurality of different network operators is associated with a particular domain proxy that is communicatively coupled to the CBSD, the method further comprising:
receiving, by the computing system from the SAS administrator, a SAS message associated with a particular CBRS channel of the plurality of CBRS channels identified by the consolidated spectrum grant;
determining, by the computing system, a particular network operator of the plurality of different network operators is an intended recipient of the SAS message based on the particular CBRS channel associated with the SAS message; and
providing, by the computing system, the SAS message to the particular domain proxy associated with the particular network operator that is the intended recipient of the SAS message.

11. The method of claim 10, wherein the SAS message comprises one of a SAS authorization message or a SAS heartbeat message.

12. The method of claim 1, wherein the computing system is configured to implement a multi-operator radio access network (RAN) framework.

13. The method of claim 12, wherein the multi-operator RAN framework is configured to facilitate communication between each network operator and the CBRS network via the CBSD.

14. The method of claim 12, wherein each network operator communicates over at least one CBRS channel, and wherein each network operator comprises a different core network.

15. A computing system, comprising:
one or more computing devices operable to:
generate a consolidated registration object associated with a plurality of different network operators, the consolidated registration object identifying a requested frequency range in a Citizens Broadband Radio Service (CBRS) network, the requested frequency range comprising a plurality of CBRS channels, at least one CBRS channel being associated with each network operators of the plurality of different network operators; and
cause a Citizens Broadband Radio Service device (CBSD) to operate on the requested frequency range identified by the consolidated registration object.

16. The computing system of claim 15, wherein the computing system is configured to implement a multi-operator radio access network (RAN) framework.

17. The computing system of claim 16, wherein the multi-operator RAN framework is configured to facilitate communication between each network operator and the CBRS network via the CBSD.

18. The computing system of claim 15, wherein each network operator communicates over at least one CBRS channel, and wherein each network operator comprises a different core network.

19. The computing system of claim 15, wherein:
to generate the consolidated registration object, the one or more computing devices are operable to:
obtain a Spectrum Access System (SAS) registration object from each network operator of the plurality of different network operators; and
generate the consolidated registration object based on the SAS registration object obtained from each network operator of the plurality of different network operators; and
to cause the CBSD to operate on the requested frequency range identified by the consolidated registration object, the one or more computing devices are operable to:
provide the consolidated registration object to a SAS administrator; and
subsequent to providing the consolidated registration object to the SAS administrator, obtain a consolidated spectrum grant identifying the plurality of CBRS channels of the requested frequency range.

20. A non-transitory computer-readable storage medium that includes executable instructions configured to cause a processor device of a computing system to:
generate a consolidated registration object associated with a plurality of different network operators, the consolidated registration object identifying a requested frequency range in a Citizens Broadband Radio Service (CBRS) network, the requested frequency range comprising a plurality of CBRS channels, at least one CBRS channel being associated with each network operators of the plurality of different network operators; and
cause a Citizens Broadband Radio Service device (CBSD) to operate on the requested frequency range identified by the consolidated registration object.
